(19) United States
(12) Patent Application Publication
(10) Pub. No.: US 2024/0186056 A1
(43) Pub. Date: Jun. 6, 2024

(54) COIL COMPONENT AND MANUFACTURING METHOD THEREFOR

(71) Applicant: TDK Corporation, Tokyo (JP)

(72) Inventors: Yuuichi KAWAGUCHI, Tokyo (JP); Kazuhiro YOSHIKAWA, Tokyo (JP); Tomonaga NISHIKAWA, Tokyo (JP); Naoaki FUJII, Tokyo (JP); Liyi CHEN, Tokyo (JP)

(21) Appl. No.: 18/525,613

(22) Filed: Nov. 30, 2023

(30) Foreign Application Priority Data
Dec. 1, 2022 (JP) 2022-192697

(51) Int. Cl. H01F 27/28; H01F 27/32; H01F 41/04; H01F 41/12

(52) U.S. Cl. CPC H01F 27/2804; H01F 27/324; H01F 41/043; H01F 41/12

(57) ABSTRACT

Disclosed herein is a coil component that includes a magnetic element body, a coil pattern and a conductor post embedded in the magnetic element body, a post protective film provided between the conductor post and the magnetic element body, a cover insulating film covering a mounting surface of the magnetic element body, and a terminal electrode provided on the cover insulating film and connected to the conductor post through a first opening formed in the cover insulating film. The terminal electrode includes: a first conductor layer contacting the conductor post through the first opening and having a second opening through which a part of the conductor post is exposed; and a second conductor layer having a resistance value lower than the first conductive material, covering the first conductor layer, and contacting the part of the conductor post through the second opening.

### CROSS-REFERENCE TO RELATED APPLICATION

This application claims the benefit of Japanese Patent Application No. 2022-192697, filed on Dec. 1, 2022, the entire disclosure of which is incorporated by reference herein.

### BACKGROUND OF THE ART

### Field of the Art

The present disclosure relates to a coil component and a manufacturing method therefor and, more particularly, to a coil component having a structure in which a coil pattern and a conductor post connected thereto are embedded in a magnetic element body and a manufacturing method for such a coil component.

### Description of Related Art

JP 2020-155509A discloses a coil component having structure in which a coil pattern and a conductor post connected thereto are embedded in a magnetic element body. In the invention disclosed in JP 2020-155509A, an insulating film is interposed between the conductor post and the magnetic element body to thereby achieve insulation therebetween.

In the coil component described in JP 2020-155509A, a terminal electrode connected to the conductor post is made of a conductive resin material.

### SUMMARY

The present disclosure describes a technology for reducing a connection resistance between the conductor post and the terminal electrode while enhancing an insulting property between the conductor post and the magnetic element body and that between the terminal electrode and the magnetic element body.

A coil component according to one aspect of the present disclosure includes: a magnetic element body having a mounting surface; a coil pattern embedded in the magnetic element body; a conductor post embedded in the magnetic element body, the conductor post having a first end connected to the coil pattern and a second end; a post protective film provided between the conductor post and the magnetic element body; a cover insulating film covering the mounting surface of the magnetic element body; and a terminal electrode provided on the cover insulating film and connected to the second end of the conductor post through a first opening formed in the cover insulating film. The terminal electrode includes: a first conductor layer which is made of a first conductive material, contacts the second end of the conductor post through the first opening, and has a second opening through which a part of the second end of the conductor post is exposed; and a second conductor layer which is made of a second conductive material having a resistance value lower than the first conductive material, covers a surface of the first conductor layer, and contacts the part of the second end of the conductor post through the second opening. The first opening does not overlap the mounting surface of the magnetic element body.

A coil component manufacturing method according to one aspect of the present disclosure includes: embedding a coil pattern and a conductor post having a first end connected to the coil pattern and a second end in a magnetic element body; polishing a surface of the magnetic element body to form a mounting surface until the second end of the conductor post is exposed; forming a cover insulating film on the mounting surface of the magnetic element body that is flush with the second end of the conductor post; forming a first opening in the cover insulating film so as to expose therethrough the second end of the conductor post and so as not to expose therethrough the mounting surface of the magnetic element body; forming a first conductor layer made of a first conductive material on the cover insulating film such that the first conductor layer contacts the second end of the conductor post through the first opening; forming a second opening in the first conductor layer so as to expose therethrough a part of the second end of the conductor post and so as not to expose therethrough the cover insulating film; and forming a second conductor layer made of a second conductive material having a resistance value lower than the first conductive material such that the second conductor layer covers a surface of the first conductor layer and contacts the part of the second end of the conductor post through the second opening.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic perspective view for explaining the outer appearance of a coil component 1 according to an embodiment of the present disclosure;

FIG. 2 is a schematic cross-sectional view of the coil component 1;

FIGS. 3A to 3C are schematic plan views for explaining the positional relation between the conductor post P1, the opening 21a formed in the cover insulating film 21, and the opening 31a formed in the conductor layer 31;

FIG. 4 is a schematic plan view for explaining the pattern shape of the conductor layer C0;

FIG. 5 is a schematic plan view for explaining the pattern shape of the conductor layer C1;

FIG. 6 is a schematic plan view for explaining the pattern shape of the conductor layer C2;

FIG. 7 is a schematic plan view for explaining the pattern shape of the conductor layer C3; and

FIGS. 8 to 17 are process views for explaining the manufacturing method for the coil component 1.

### DETAILED DESCRIPTION OF THE EMBODIMENTS

Preferred embodiments of the present disclosure will be explained below in detail with reference to the accompanying drawings.

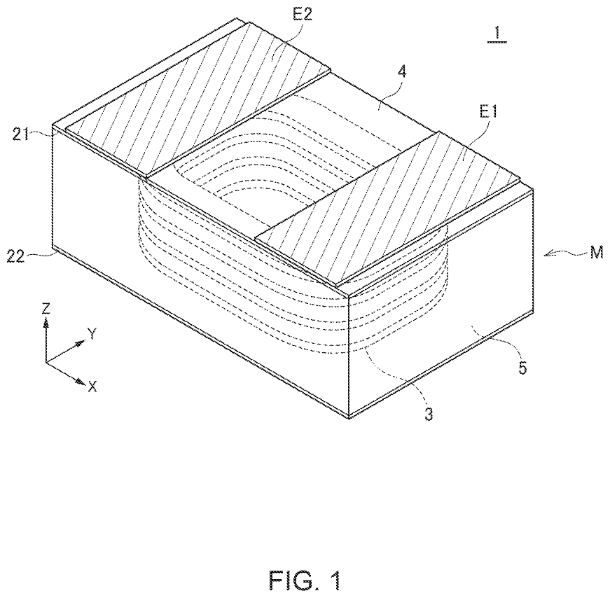

FIG. 1 is a schematic perspective view for explaining the outer appearance of a coil component 1 according to an embodiment of the present disclosure.

As illustrated in FIG. 1, the coil component 1 according to the present embodiment is a chip type coil component having a structure in which a coil part 3 having a coil axis extending in the Z-direction is embedded in a magnetic element body M. The magnetic element body M has a mounting surface 4 and an upper surface 5 which are orthogonal to the coil axis and constitute the XY plane. The mounting surface 4 and upper surface 5 are positioned on the opposite sides to each other. The mounting surface 4 is provided with terminal electrodes E1 and E2. At the time of mounting, the terminal electrodes E1 and E2 are soldered onto a circuit board with the mounting surface 4 facing the circuit board. That is, the vertical direction of the coil component 1 illustrated in FIG. 1 differs by 180° from that at the time of mounting.

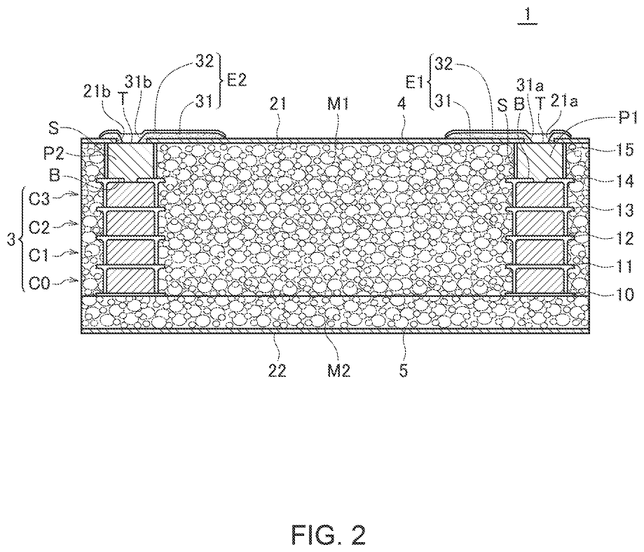

FIG. 2 is a schematic cross-sectional view of the coil component 1 according to the present embodiment.

As illustrated in FIG. 2, the coil component 1 according to the present embodiment has interlayer insulating films 10 to 14 and conductor layers C0 to C3 which are alternately stacked in the coil axial direction (Z-direction). The conductor layers C0 to C3 are made of Cu or the like and constitute a coil part 3. The magnetic element body M includes magnetic resin layers M1 and M2. The magnetic resin layer M1 is positioned in the inner diameter area and radially outside area of the coil part 3 and on one side in the coil axis direction of the coil part 3. The magnetic resin layer M2 is provided on the other side in the coil axial direction of the coil part 3. The magnetic resin layers M1 and M2 are made of a composite magnetic material containing a magnetic filler and binder resin. The composite magnetic material constituting the magnetic resin layer M1 and composite magnetic material constituting the magnetic resin layer M2 may be the same or different. The magnetic filler may be a metal magnetic material such as iron (Fe) or a permalloy-base material. The binder resin may be epoxy resin.

Conductor posts P1 and P2 are embedded in the magnetic resin layer M1. The conductor posts P1 and P2 are made of Cu or the like and are pillar-shaped conductors extending in the Z-direction. A lower surface B at one end of the conductor post P1 is connected to one end of a coil constituted by the conductor layers C0 to C3, and a lower surface B at one end of the conductor post P2 is connected to the other end of the coil constituted by the conductor layers C0 to C3. On the other hand, upper surfaces T at the other ends of the respective conductor posts P1 and P2 are exposed from the mounting surface 4 so as to be flush with the mounting surface 4 and are connected respectively to the terminal electrodes E1 and E2. Side surfaces S (surfaces along the Z-direction) of the conductor posts P1 and P2 are covered with a post protective film 15. Thus, the post protective film 15 is interposed between the magnetic element body M and the conductor posts P1 and P2, so that contact between the magnetic element body M and the conductor posts P1 and P2 is prevented to insulate them from each other. Further, when the coil component 1 according to the present embodiment having the thus configured conductor posts P1 and P2 is mounted on a circuit board or the like, stress is relaxed by the conductor posts P1 and P2 to reduce damage to the coil part 3. This increases mounting reliability of the coil component 1.

The mounting surface 4 and upper surface 5 of the magnetic element body M are covered respectively with cover insulating films 21 and 22. The cover insulating film 22 covers substantially the entire upper surface 5, while the cover insulating film 21 has openings 21a and 21b at positions overlapping respectively the conductor posts P1 and P2. As a result, the upper surfaces T (XY plane) of the respective conductor posts P1 and P2 are exposed through the respective openings 21a and 21b of the cover insulating film 21. The openings 21a and 21b are smaller in area than the upper surfaces T of the conductor posts P1 and P2, and thus the cover insulating film 21 partly covers the upper surfaces T of the conductor posts P1 and P2. On the cover insulating film 21, the terminal electrodes E1 and E2 are provided. The terminal electrodes E1 and E2 are each constituted by a conductor layer 31 which is made of a conductive resin material containing metal powder of Ag and binder resin and a conductor layer 32 which is made of metal and formed on the conductor layer 31. Therefore, a conductive material constituting the conductor layer 32 has a resistance value lower than that of a conductive material constituting the conductor layer 31.

The conductor layer 32 may be a laminated film of a plurality of metals such as Ni and Sn. The laminated film of Ni and Sn has a sufficiently lower resistance than a conductive resin material such as a silver paste and has high solder heat resistance and high solder wettability. On the other hand, as compared with the conductor layer 32 positioned in the upper layer, the conductor layer 31 positioned in the lower layer can provide high adhesion to the cover insulating film 21 and relax thermal shock and external stress thanks to high flexibility of conductive resin, thus increasing reliability.

The terminal electrodes E1 and E2 are connected respectively to the upper surfaces T of the conductor posts P1 and P2 through the respective openings 21a and 21b of the cover insulating film 21. Covering the mounting surface 4 of the magnetic element body M with the cover insulating film 21 as described above prevents contact between the magnetic element body M and the terminal electrodes E1 and E2, thereby increasing product reliability. Further, covering the upper surface 5 of the magnetic element body M with the cover insulating film 22 increases product reliability and allows a direction mark or the like to be provided on the upper surface 5.

The conductor layer 31 made of a conductive resin material has openings 31a and 31b through which the upper surfaces T of the conductor posts P1 and P2 are partly exposed. This makes a part of the upper surface T of each of the conductor posts P1 and P2 directly contact the conductor layer 32 made of metal without through the conductor layer 31 made of a conductive resin material. As a result, as compared with a case where the conductor layer 31 made of a conductive resin layer is interposed completely between the conductor layer 32 and the conductor posts P1 and P2, a connection resistance between the conductor layer 32 and the conductor posts P1 and P2 can be reduced.

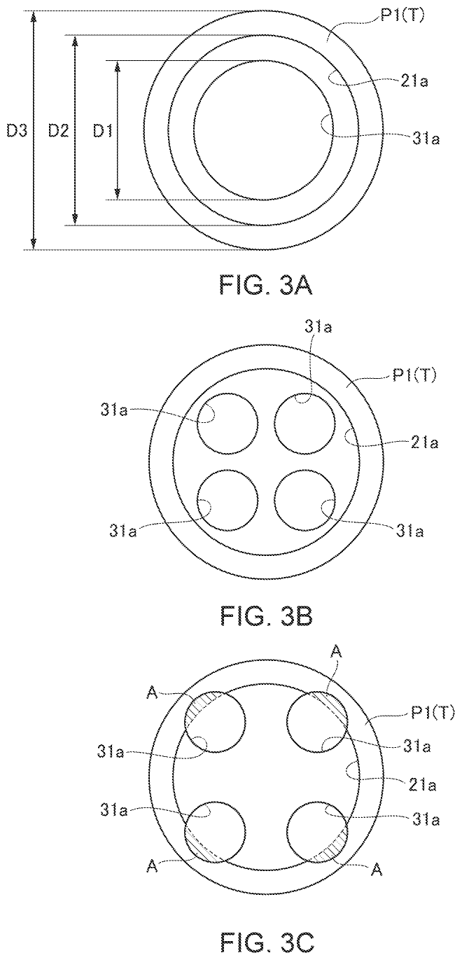

FIGS. 3A to 3C are schematic plan views for explaining the positional relation between the conductor post P1, the opening 21a formed in the cover insulating film 21, and the opening 31a formed in the conductor layer 31. The same applies to the positional relation between the conductor post P2, the opening 21b formed in the cover insulating film 21, and the opening 31b formed in the conductor layer 31.

In the example illustrated in FIG. 3A, assuming that the diameter of the upper surface T of the conductor post P1 is D3, the diameter of the opening 21a of the cover insulating film 21 is D2, and the diameter of the opening 31a of the conductor layer 31 is D1,
D1<D2<D3 is satisfied.
   The opening 21a of the cover insulating film 21 entirely overlaps the upper surface T of the conductor post P1 and does not overlap the mounting surface 4 of the magnetic element body M. This prevents the terminal electrode E1 from directly contacting the magnetic element body M, thus increasing product reliability. Further, the opening 31a of the conductor layer 31 entirely overlaps the opening 21a of the cover insulating film 21 and does not overlap the cover insulating film 21. With this configuration, the conductor layer 32 made of metal or the like does not directly contact the cover insulating film 21 to prevent peeling at the interface therebetween. Further, the outer peripheral area of the upper surface T of the conductor post P1 is covered with the cover insulating film 21, so that the upper end of the post protective film 15 contacts the cover insulating film 21. This allows the post protective film 15 and the cover insulating film 21 to tightly adhere to each other, thus increasing reliability.

In the example illustrated in FIG. 3B, a plurality of openings 31a are formed in the conductor layer 31. All of the openings 31a overlap the opening 21a of the cover insulating film 21 and none of them overlap the cover insulating film 21. As described above, a plurality of the openings 31a may be formed in the conductor layer 31. Further, although not illustrated, the opening 31a need not necessarily have a circular shape but may have various planar shapes such as a rectangular shape, a cross shape, and a donut shape.

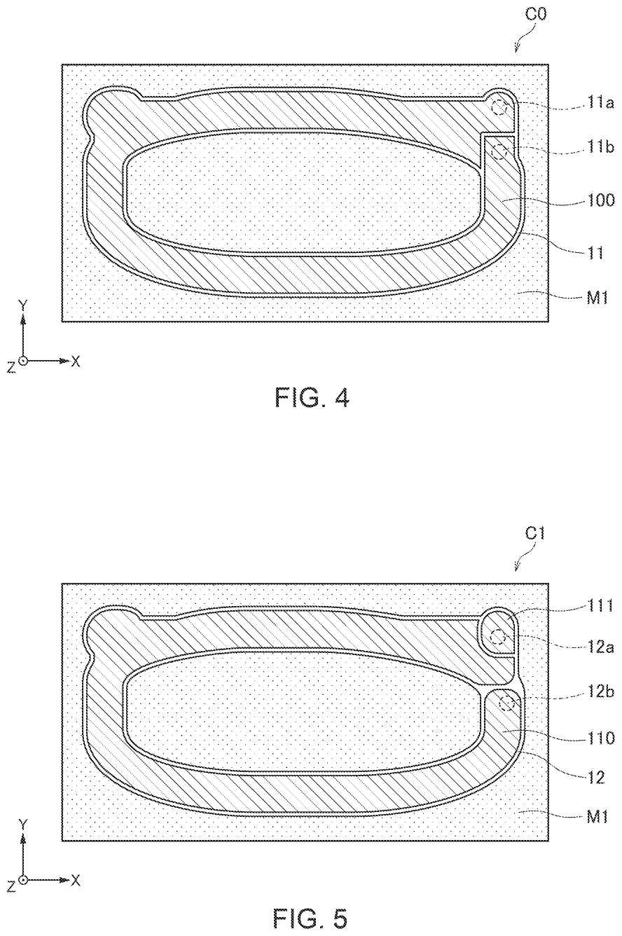

FIGS. 4 to 7 are schematic plan views for explaining the pattern shapes of the conductor layers C0 to C3.

As illustrated in FIG. 4, the conductor layer C0 is provided with a coil pattern 100. The coil pattern 100 is a pattern wound in about one turn, and both ends thereof are connected to the conductor layer C1 through vias 11a and 11b.

As illustrated in FIG. 5, the conductor layer C1 is provided with a coil pattern 110 and a connection pattern 111. The coil pattern 110 is a pattern wound in about one turn. One end of the coil pattern 110 is connected to the other end of the coil pattern 100 in the conductor layer C0 through the via 11b formed in the interlayer insulating film 11, and the other end thereof is connected to the conductor layer C2 through a via 12b formed in the interlayer insulating film 12. The connection pattern 111 is provided at a position overlapping the one end of the coil pattern 100 in the conductor layer C0. The connection pattern 111 is connected to the one end of the coil pattern 100 in the conductor layer C0 through a via 11a formed in the interlayer insulating film 11 and to the conductor layer C2 through a via 12a formed in the interlayer insulating film 12.

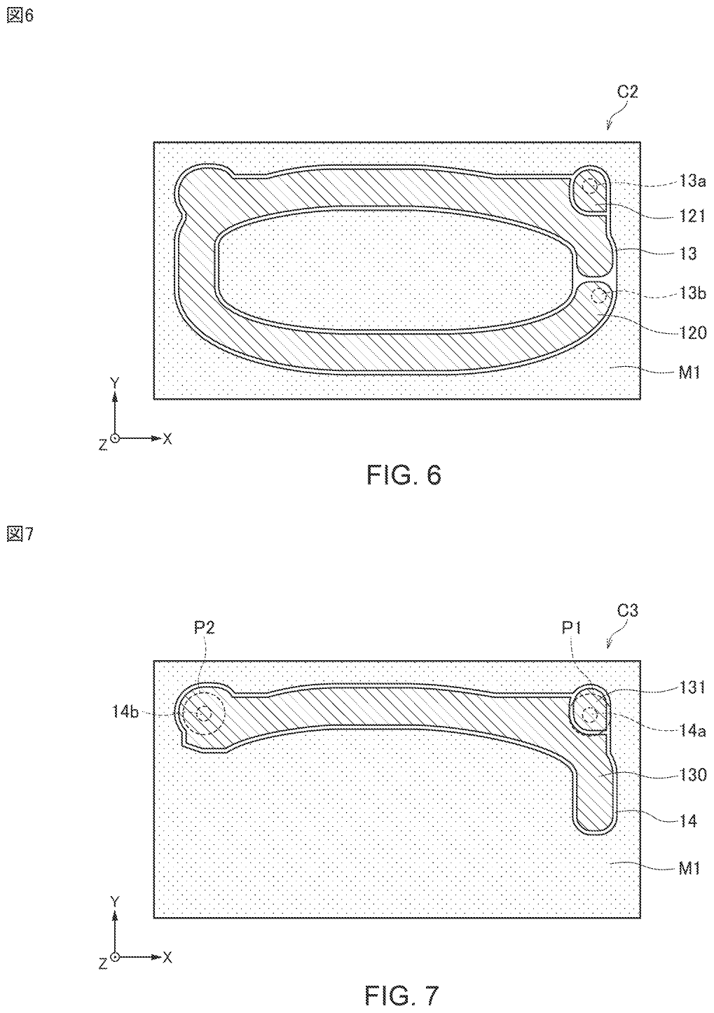

As illustrated in FIG. 6, the conductor layer C2 is provided with a coil pattern 120 and a connection pattern 121. The coil pattern 120 is a pattern wound in about one turn. One end of the coil pattern 120 is connected to the other end of the coil pattern 110 in the conductor layer C1 through the via 12b formed in the interlayer insulating film 12, and the other end thereof is connected to the conductor layer C3 through a via 13b formed in the interlayer insulating film 13. The connection pattern 121 is provided at a position overlapping the connection pattern 111 provided in the conductor layer C1. The connection pattern 121 is connected to the connection pattern 111 in the conductor layer C1 through the via 12a formed in the interlayer insulating film 12 and to the conductor layer C3 through a via 13a formed in the interlayer insulating film 13.

As illustrated in FIG. 7, the conductor layer C3 is provided with a coil pattern 130 and a connection pattern 131. The coil pattern 130 is a pattern wound in about 0.5 turns. One end of the coil pattern 130 is connected to the other end of the coil pattern 120 in the conductor layer C2 through the via 13b formed in the interlayer insulating film 13, and the other end thereof is connected to the conductor post P2 through a via 14b formed in the interlayer insulating film 14. The connection pattern 131 is provided at a position overlapping the connection pattern 121 provided in the conductor layer C2. The connection pattern 131 is connected to the connection pattern 121 in the conductor layer C2 through the via 13a formed in the interlayer insulating film 13 and to the conductor post P1 through a via 14a formed in the interlayer insulating film 14.

With the above configuration, the coil patterns 100, 110, 120, and 130 are connected in series between the terminal electrodes E1 and E2 to form a coil of about 3.5 turns in total. The coil component 1 according to the present embodiment is an embedded type coil component in which the coil part 3 including the alternately stacked interlayer insulating films 10 to 14 and conductor layers C0 to C3 is embedded in the magnetic element body M, which is different in structure from a stacked type coil component in which magnetic sheets made of ceramic or the like and coil patterns are alternately stacked. For example, in the stacked type coil component, a magnetic sheet is interposed between coil patterns adjacent in the stacking direction, while in the coil component 1 according to the present embodiment, coil patterns adjacent in the stacking direction are insulated by the interlayer insulating film, and the magnetic element body M is not interposed between the coil patterns. The coil component 1 according to the present embodiment is also different in structure from a sheet coil of a type in which a coil pattern is formed on a printed board.

In the present embodiment, the coil patterns 100, 110, 120, and 130 and connection patterns, 111, 121, and 131 constituting the coil part 3 are insulated from the magnetic element body M by the interlayer insulating films 10 to 14, the conductor posts P1 and P2 are insulated from the magnetic element body M by the post protective film 15, and the terminal electrodes E1 and E2 are insulated from the magnetic element body M by the cover insulating film 21. Thus, all the conductor patterns are insulated from the magnetic element body M, allowing achievement of superior insulating properties.

Although the interlayer insulating films 10 to 14, post protective film 15, and cover insulating films 21 and 22 are not particularly limited in material, the post protective film 15 and cover insulating films 21 and 22 may be made of mutually different insulating materials. This is because the post protective film 15, which is embedded in the magnetic element body M and contacts the conductor posts P1 and P2, and the cover insulating films 21 and 22, which constitute the outermost layer of the coil component 1, are different in characteristics required to increase product reliability.

Specifically, for the post protective film 15, an insulating material containing a filler made of an inorganic material such as silica and thus having a low thermal expansion coefficient is selected, whereby it is possible to reduce a difference in thermal expansion coefficient from Cu which is the material of the conductor posts P1 and P2. On the other hand, for the cover insulating films 21 and 22, a photosensitive resin material with a low Young's modulus is selected, whereby it is possible to enhance physical protection characteristics of the magnetic element body M on the mounting surface 4 and upper surface 5 and to facilitate formation of the openings 21a and 21b. Thus, the post protective film 15 is preferably made of an insulating material having a lower thermal expansion coefficient than the cover insulating films 21 and 22, and the cover insulating films 21 and 22 are preferably made of an insulating material having a lower Young's modulus than the post protective film 15. Further, by adding a magnetic filler to an insulating material constituting the cover insulating films 21 and 22, inductance can be further increased.

Since the interlayer insulating films 10 to 14 are embedded in the magnetic element body M and contact the coil patterns 100, 110, 120, and 130 and the connection patters 111, 121, and 131, they may be made of the same insulating material as that of the post protective film 15.

By selecting the same insulating material for the interlayer insulating films 10 to 14 and post protective film 15, material cost can be reduced.

The following describes a manufacturing method for the coil component 1 according to the present embodiment.

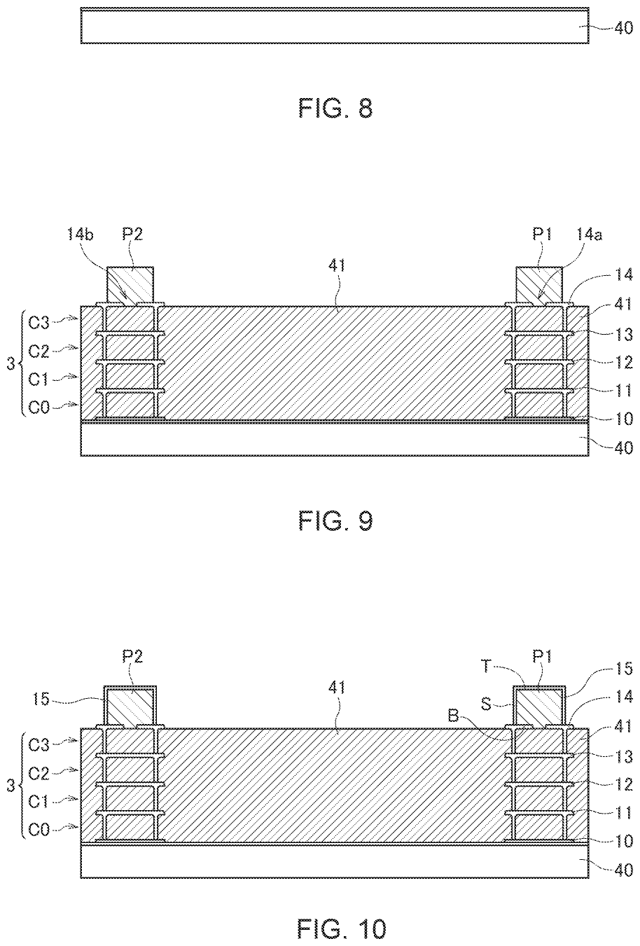

FIGS. 8 to 17 are process views for explaining the manufacturing method for the coil component 1 according to the present embodiment. Although FIGS. 8 to 17 each illustrate only an area corresponding to one coil component 1, a plurality of coil components 1 are actually manufactured at the same time using an aggregate substrate.

A support substrate 40 is prepared (FIG. 8), and the interlayer insulating films 10 to 14 and the conductor layers C0 to C3 are alternately formed to form the coil part 3. After that, the vias 14a and 14b are formed in the interlayer insulating film 14, and the conductor posts P1 and P2 are formed (FIG. 9). The conductor layers C0 to C3 and conductor posts P1 and P2 can be formed by electrolytic plating. The conductor layers C0 to C3 include a sacrificial pattern 41 positioned in the inner diameter area of the coil part 3 and in the outside area of the coil part 3.

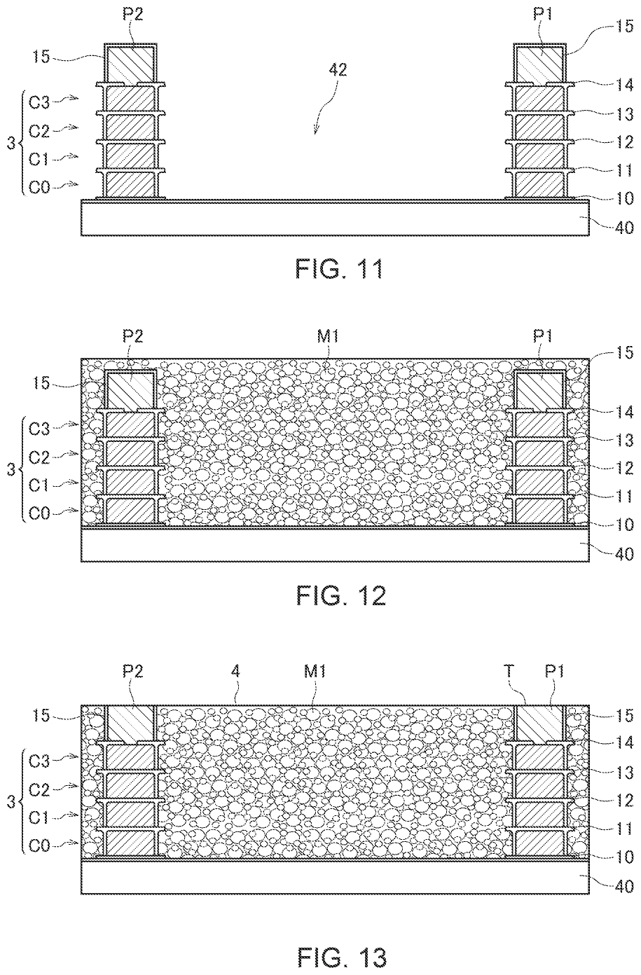

Then, the post protective film 15 covering the entire exposed surface of each of the conductor posts P1 and P2 is formed (FIG. 10). The entire exposed surface of each of the conductor posts P1 and P2 includes the side surface S along the Z-direction and the upper surface T constituting the XY plane. In this state, wet etching is performed to remove the sacrificial pattern 41 (FIG. 11). The coil patterns constituting the coil part 3 are covered with the interlayer insulating films 10 to 14 and thus will not be etched. Similarly, the conductor posts P1 and P2 are covered with the post protective film 15 and thus will not be etched. As a result, a space 42 is formed in the inner diameter area and outside area of the coil part 3.

Then, the space 42 formed as a result of the removal of the sacrificial pattern 41 is filled with the magnetic resin layer M1 (FIG. 12). Then, the surface of the magnetic resin layer M1 is polished until the conductor posts P1 and P2 are exposed (FIG. 13). As a result, the mounting surface 4 of the magnetic resin layer M1 and the upper surfaces T of the conductor posts P1 and P2 become flush with one another. Further, as compared with a state before polishing, flatness of the magnetic resin layer M1 on the mounting surface 4 side is enhanced.

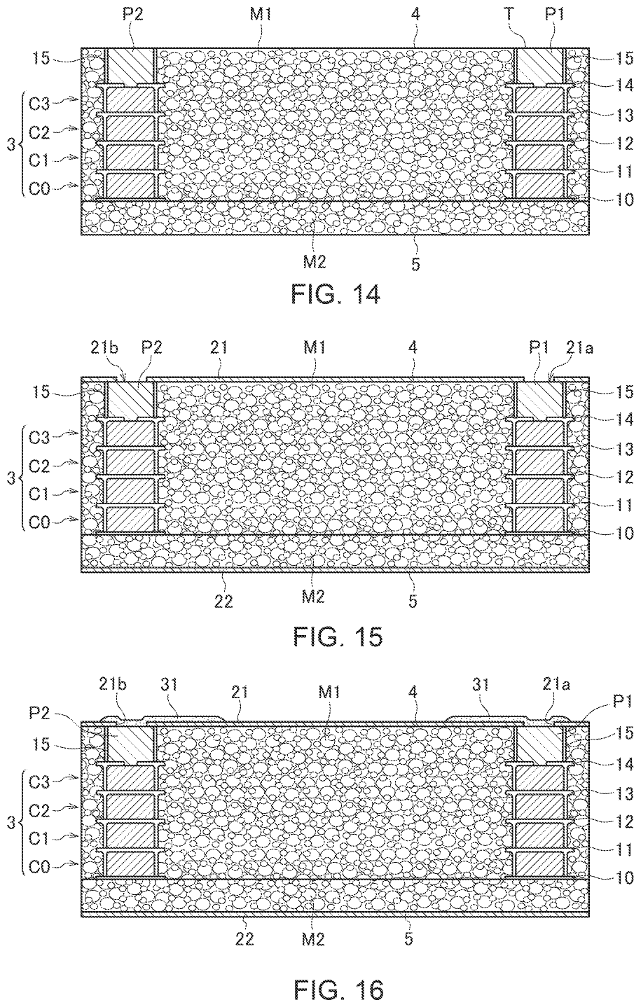

Then, the support substrate 40 is removed, and the magnetic resin layer M2 is formed on the lower surface side of the magnetic resin layer M1 so as to cover the interlayer insulating film 10 (FIG. 14). Thereafter, the surface of the magnetic resin layer M2 may be polished for smoothing the upper surface 5. Then, the cover insulating films 21 and 22 are formed respectively on the mounting surface 4 and upper surface 5 of the magnetic element body M, and the openings 21a and 21b are formed in the cover insulating film 21 so as to expose therethrough a part of the upper surface T of each of the conductor posts P1 and P2 (FIG. 15). At this time, the openings 21a and 21b are formed at positions entirely overlapping respectively the upper surfaces T of the conductor posts P1 and P2 and not overlapping the mounting surface 4 of the magnetic element body M. Therefore, the mounting surface 4 of the magnetic element body M is by no means exposed through the openings 21a and 21b. Further, as described above, flatness of the magnetic resin layer M1 on the mounting surface 4 side is enhanced by polishing, so that the cover insulating film 21 may have a reduced thickness. This can reduce the entire thickness of the coil component 1. On the other hand, the thickness of the post protective film 15 needs to be large to some extent since it functions as a resist for protecting the conductor posts P1 and P2 at the time of removal of the sacrificial pattern illustrated in FIG. 11. Thus, the film thickness of the post protective film may be larger than that of the cover insulating film 21.

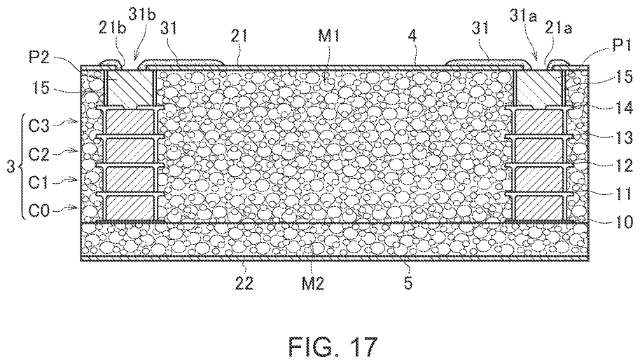

Then, the conductor layer 31 made of a conductive resin material is formed on the cover insulating film 21 so as to be connected to the conductor posts P1 and P2 through the respective openings 21a and 21b (FIG. 16). The conductor layer 31 can be formed by a thick-film formation method such as screen printing. As described above, the openings 21a and 21b are formed at positions not overlapping the mounting surface 4 of the magnetic element body M, so that the conductor layer 31 by no means directly contact the magnetic element body M. Then, laser beam is irradiated to form the openings 31a and 31b in the conductor layer 31 (FIG. 17). At this time, the openings 31a and 31b are formed at positions entirely overlapping respectively the openings 21a and 21b formed in the cover insulating film 21 and not overlapping the cover insulating film 21. Therefore, the cover insulating film 21 will not be exposed through the openings 31a and 31b.

Nonetheless, under a condition where the cover insulating film 21 is removed by the laser beam irradiation, the irradiation position of laser beam may partly overlap the cover insulating film 21. For example, as denoted by the symbol A in FIG. 3C, when laser beam is irradiated so as to partly overlap the cover insulating film 21, a part or the whole of the cover insulating film 21 corresponding to the area denoted by the symbol A is removed, and the conductor post P1 is newly exposed. Under such a condition, the laser beam irradiation position may partly overlap the cover insulating film 21. Further, as illustrated in FIG. 3B, when a plurality of openings 31a having a smaller diameter are formed by the laser beam irradiation, a higher degree of positional accuracy can be achieved than when a single opening 31a having a large diameter is formed by the laser beam irradiation. Further, instead of forming the openings 31a and 31b by the laser beam irradiation, the conductor layer 31 may be formed using a screen mask to form the openings 31a and 31b at the time of screen printing.

Then, the conductor layer 32 constituted by a laminated film of Ni and Sn is formed using a barrel plating method or the like, followed by singulation by dicing, whereby the coil component 1 according to the present embodiment is completed.

As described above, in the present embodiment, the terminal electrodes E1 and E2 are formed not directly on the mounting surface but through the cover insulating film 21, making it possible to prevent contact between the magnetic element body M and the terminal electrodes E1 and E2. In addition, the openings 31a and 31b are formed in the conductor layer 31 constituting the terminal electrodes E1 and E2, so that a part of the conductor layer 32 having a lower resistance directly contacts the conductor posts P1 and P2. This allows reduction in the connection resistance between the conductor posts P1 and P2 and the terminal electrodes E1 and E2.

While the preferred embodiment of the present disclosure has been described, the present disclosure is not limited to the above embodiment, and various modifications may be made within the scope of the present disclosure, and all such modifications are included in the present disclosure.

For example, although the coil part 3 includes four conductor layers C0 to C3 in the above embodiment, the number of conductor layers included in the coil part 3 is not particularly limited to a specific number. Further, although the coil patterns 100, 110, and 120 provided respectively in the conductor layers C0 to C2 are each wound in about one turn in the above embodiment, the number of turns of the coil pattern provided in each conductor layer is not particularly limited to a specific number.

The technology according to the present disclosure includes the following configuration examples but not limited thereto.

A coil component according to one aspect of the present disclosure includes: a magnetic element body having a mounting surface; a coil pattern embedded in the magnetic element body; a conductor post embedded in the magnetic element body and whose one end is connected to the coil pattern; a post protective film provided between the conductor post and the magnetic element body; a cover insulating film covering the mounting surface of the magnetic element body; and a terminal electrode provided on the cover insulating film and connected to the other end of the conductor post through a first opening formed in the cover insulating film. The terminal electrode includes a first conductor layer which is made of a first conductive material, contacts the other end of the conductor post through the first opening, and has a second opening through which a part of the other end of the conductor post is exposed and a second conductor layer which is made of a second conductive material having a resistance value lower than the first conductive material, covers the surface of the first conductor layer, and contacts a part of the other end of the conductor post through the second opening. The first opening does not overlap the mounting surface of the magnetic element body. With this configuration, it is possible to reduce a connection resistance between the conductor post and the terminal electrode while enhancing an insulting property between the conductor post and the magnetic element body and that between the terminal electrode and the magnetic element body.

In the above coil component, the second opening need not necessarily overlap the cover insulating film. This can ensure a sufficient contact area between the second conductor layer and the conductor post.

In the above coil component, the cover insulating film may cover a part of the other end of the conductor post. This facilitates formation of the first opening.

In the above coil component, the post protective film and the cover insulating film may contact each other. This allows the post protective film and cover insulating film to tightly adhere to each other, thus increasing reliability.

In the above coil component, the first conductive material may be conductive resin. This can enhance adhesion between the terminal electrode and the cover insulating film.

In the above coil component, the second conductive material may be metal. This can reduce the resistance of the terminal electrode and achieve high solder heat resistance and high solder wettability.

In the above coil component, the first conductor layer may have a plurality of the second openings. This enhances the positional accuracy of the second opening.

A coil component manufacturing method according to one aspect of the present disclosure includes the steps of: embedding a coil pattern and a conductor post whose one end is connected to the coil pattern in a magnetic element body; polishing the surface of the magnetic element body until the other end of the conductor post is exposed; forming a cover insulating film on a mounting surface of the magnetic element body that is flush with the other end of the conductor post; forming a first opening in the cover insulating film so as to expose therethrough the other end of the conductor post and so as not to expose therethrough the mounting surface of the magnetic element body; forming a first conductor layer made of a first conductive material on the cover insulating film such that it contacts the other end of the conductor post through the first opening; forming a second opening in the first conductor layer so as to expose therethrough a part of the other end of the conductor post and so as not to expose therethrough the cover insulating film; and forming a second conductor layer made of a second conductive material having a resistance value lower than the first conductive material such that it covers the surface of the first conductor layer and contacts a part of the other end of the conductor post through the second opening. Thus, there can be manufactured a coil component having a high insulting property between the conductor post and the magnetic element body and that between the terminal electrode and the magnetic element body and having a reduced connection resistance between the conductor post and the terminal electrode.

In the above coil component manufacturing method, the step of forming the second opening may be performed by irradiating the first conductor layer with laser beam. This facilitates the formation of the second opening.

What is claimed is:

1. A coil component comprising:
a magnetic element body having a mounting surface;
a coil pattern embedded in the magnetic element body;
a conductor post embedded in the magnetic element body, the conductor post having a first end connected to the coil pattern and a second end;
a post protective film provided between the conductor post and the magnetic element body;
a cover insulating film covering the mounting surface of the magnetic element body; and
a terminal electrode provided on the cover insulating film and connected to the second end of the conductor post through a first opening formed in the cover insulating film,
wherein the terminal electrode includes:
a first conductor layer which is made of a first conductive material, contacts the second end of the conductor post through the first opening, and has a second opening through which a part of the second end of the conductor post is exposed; and
a second conductor layer which is made of a second conductive material having a resistance value lower than the first conductive material, covers a surface of the first conductor layer, and contacts the part of the second end of the conductor post through the second opening, and
wherein the first opening does not overlap the mounting surface of the magnetic element body.

2. The coil component as claimed in claim 1, wherein the second opening does not overlap the cover insulating film.

3. The coil component as claimed in claim 1, wherein the cover insulating film covers a part of the second end of the conductor post.

4. The coil component as claimed in claim 1, wherein the post protective film and the cover insulating film contact each other.

5. The coil component as claimed in claim 1, wherein the first conductive material is conductive resin.

6. The coil component as claimed in claim 5, wherein the second conductive material is metal.

7. The coil component as claimed in claim 1, wherein the first conductor layer has a plurality of the second openings.

8. A method of manufacturing a coil component, the method comprising:
embedding a coil pattern and a conductor post having a first end connected to the coil pattern and a second end in a magnetic element body;
polishing a surface of the magnetic element body to form a mounting surface until the second end of the conductor post is exposed;
forming a cover insulating film on the mounting surface of the magnetic element body that is flush with the second end of the conductor post;
forming a first opening in the cover insulating film so as to expose therethrough the second end of the conductor post and so as not to expose therethrough the mounting surface of the magnetic element body;
forming a first conductor layer made of a first conductive material on the cover insulating film such that the first conductor layer contacts the second end of the conductor post through the first opening;
forming a second opening in the first conductor layer so as to expose therethrough a part of the second end of the conductor post and so as not to expose therethrough the cover insulating film; and
forming a second conductor layer made of a second conductive material having a resistance value lower than the first conductive material such that the second conductor layer covers a surface of the first conductor layer and contacts the part of the second end of the conductor post through the second opening.

9. The method of manufacturing a coil component as claimed in claim 8, wherein the forming the second opening is performed by irradiating the first conductor layer with laser beam.
